(19) United States
(12) Patent Application Publication
(10) Pub. No.: US 2008/0182223 A1
(43) Pub. Date: Jul. 31, 2008

(54) Dental diagnostic device root canal treating apparatus using the same display unit for root canal treating apparatus and dental diagnostic/treating table

(75) Inventors: Seiichiro Yamashita, Kyoto-shi (JP); Hiroaki Kusakabe, Kyoto-shi (JP); Kazunari Matoba, Kyoto-shi (JP); Tetsuzo Ito, Kyoto-shi (JP)

Correspondence Address: Quinn Emanuel Urquhart Oliver & Hedges. LLP;Koda/Androlia, 865 S. Figueroa Street, 10th Floor, Los Angeles, CA, 90017, US

(73) Assignee: J. Morita Manufacturing Corporation

(21) Appl. No.: 11/980,248

(22) Filed: Oct. 30, 2007

(30) Foreign Application Priority Data
Oct. 31, 2006 (JP) 2006-296050

(51) Int. Cl. A61C 3/00

(52) U.S. Cl. 433/32

(57) ABSTRACT

The invention intends to provide a dental diagnostic device capable of detecting whether or not an electric leakage path which departs from a root canal, bypassing an apex is contained in a conductive path. The dental diagnostic device includes a measuring electrode, an oral electrode, a measurement signal applying means, a measuring means and a detecting means. The measuring electrode is inserted into a root canal of a tooth which is a diagnosing object. The oral electrode is brought into electric contact with oral mucosa. The measurement signal applying means applies a measurement signal in between the measuring electrode and the oral electrode. The measuring means obtains data corresponding to the electric characteristic of at least part of a conductive path between the measuring electrode and the oral electrode based on measurement of electric response to the measurement signal. The detecting means detects to see whether or not an electric leakage path bypassing an apex of a tooth is contained in a conductive path by applying a predetermined determination standard to data.

### BACKGROUND OF THE INVENTION

1. Field of the Invention

The present invention relates to a dental diagnostic device, a root canal treating apparatus, a display unit for the root canal treating apparatus and a dental diagnostic/treating table, and particularly to diagnosis and the like of the root canal of tooth.

2. Description of the Background Art

As shown in FIG. 20, a tooth of a human being is constituted of enamel 101, dentine 102 and cementum 103, and supported by an alveolar bone 104 and a gingiva 105. Dental pulp 106 exists inside a tooth, and a blood vessel and a nerve are connected to blood vessels and the like under the alveolar bone 104 from the dental pulp 106 through the root canal 107. A tip of the root canal 107 on the side of the alveolar bone 104 is referred to as an apex 108. An opening of the apex 108 on the side of the alveolar bone 104 is referred to as an apical foramen. A periodontal membrane 109 as a membrane which covers the entire dental root exists on the border between the dental root of the cementum 103 including the apex 108 and the alveolar bone 104.

As a conventional dental diagnostic device for measuring electrically the length of the root canal (root canal length), an electric root canal length measuring device (apex locator) of a type of measuring impedance of the root canal as shown in FIG. 21 is available (hereinafter, referred to simply as “root canal length measuring device”, dropping “electric”). Inside the root canal length measuring device, a signal applying portion 113 for applying a measurement signal between two electrodes 111 and 112 and a detecting resistance 114 are connected in series in order to measure an impedance value between a measuring electrode 111 inserted into the root canal 107 of a tooth 110 and an oral electrode 112.

The leading edge 115 of the measuring electrode 111 is moved toward the apex 108 with a measurement signal applied between the electrodes 111 and 112 so as to continuously measure changes in impedance between the electrodes 111 and 112 as changes in current value. Then, a condition in which the leading edge 115 of the measuring electrode 111 reaches the apical foramen through the periodontal membrane 109 is estimated based on the measurement result of the impedance and the position of the leading edge 115 of the measuring electrode 111 at that time is assumed to be the apex. The root canal length can be specified based on a depth of insertion of the measuring electrode 111 into the root canal 107 when the position of the apex 108 is detected in this manner.

As a measurement principle of the root canal length measuring device, two typical principles exist. A first principle is measuring an impedance value between the leading edge 115 of the measuring electrode 111 inserted into the root canal 107 and oral mucosa on which the oral electrode 112 paired with the electrode 111 is attached, based on a measuring signal of a single frequency, and detecting an apical position (or root canal length) using the impedance value itself (see, for example, Japanese Examined Patent Application Publication No. 62-25381). A second principle is measuring an impedance value between the leading edge 115 of the measuring electrode 111 inserted into the root canal 107 and the oral mucosa on which the oral electrode 112 paired with the electrode 111 is attached, using measuring signals of different frequencies, and detecting an apical position (or root canal length) from changes in ratio or difference of the impedance values (see for example, Japanese Patent No. 2873722). When the first and second principles are embodied into an actual root canal length measuring device, generally, a configuration is adopted in which a current value or a voltage value corresponding to the impedance value is measured so as to finally assume that the impedance value is detected. When measurement or detection of the impedance value is mentioned in this specification, it includes measurement or detection of the current value or voltage value corresponding to the impedance value.

The aforementioned first principle utilizes an empirical rule that the impedance value between the oral mucosa and the leading edge of the measuring electrode inserted into the root canal reaches a substantially constant value (6.5 kΩ) without any difference depending on the age and tooth type when the leading edge of the measuring electrode reaches the periodontal membrane through the apical foramen. That is, according to the first measuring principle, the impedance value between the periodontal membrane 109 and the oral mucosa is measured and when the value reaches a substantially constant value (6.5 kΩ), it is determined that the leading edge 115 of the measuring electrode 111 reaches the position of the apex 108, and the root canal length is specified from the insertion depth at that time of the measuring electrode 111 into the root canal 107.

In the case of the first measurement principle, however, the measurement value of impedance can be varied due to wet/dry condition in the root canal 107 or any external factor. To respond to this situation, according to the second measurement principle, when the impedance values between the leading edge 115 of the measuring electrode 111 inserted into the root canal 107 and the oral mucosa are measured with different two frequencies in order to relatively cancel an influence due to a disturbance factor such as a strong electrolyte existing in the root canal such as blood or a chemical, the apex 108 is detected based on the ratio or difference of the respective impedance values. This method utilizes the fact that impedance containing capacitive component has frequency dependence and because the quantity of information obtained from an identical object increases by using measurement signals each having a different frequency, it is intended to specify the apical position without depending on a condition within the root canal 107 or an external factor.

To detect the position of the apex 108 accurately with a conventional root canal length measuring device, it is premised that substantially all measuring current from the leading edge 115 of the measuring electrode 111 flows into the oral electrode 112 through the apical foramen. That is, because there is no problem in regarding the dentine 102 as an insulator with the measurement accuracy required at the time of measurement of the root canal length, although actually, the dentine 102 is not a complete insulator, it is an implicit presumption that there exists substantially no conductive path except the path through the root canal 107.

However, in actual measurement of the root canal length, as shown in FIG. 22, bleeding from the root canal 107 or an exudate sometimes leaks from a root canal orifice 116 to the gingiva 105 and a chemical in the root canal, which is an electrically excellent conductor, sometimes leaks from the root canal orifice 116 to the gingiva 105. If a strong electrolytic solution 117 such as blood, exudate, or a chemical in the root canal exists in an area from the root canal orifice 116 to the gingiva 105, the condition that substantially all measuring current from the leading edge of the measuring electrode flows into the oral electrode through the apical foramen, which is a prerequisite for the measurement of impedance, is not established.

That is, in the state as shown in FIG. 22, a current path from the root canal orifice 116 up to the gingiva 105 through the surface of the tooth 101 is present due to the strong electrolytic solution 117, so that an influence of leakage current flowing through this current path greatly affects the accuracy of apex detection. In FIG. 22, a current flow is indicated with arrows and a leakage current from the root canal orifice 116 to the gingiva 105 and a path from the root canal 107 to the apex 108 are shown (although actually bidirectional measurement is carried out because of measurement of alternate current, only a single direction measurement is indicated for convenience of representation). Because this leakage current is a current that does not pass through the apex 108, it is irrelevant to the measurement of impedance between the periodontal membrane 109 and the oral electrode 112, possibly causing an error.

Accordingly, a conventional root canal length measuring device disclosed in Japanese Patent Application Laid-open No. 2000-5201 is provided with compensating means for compensating for an abnormal amount of a responsive value originating from the leakage current to remove its influence for the purpose of compensating for a result of the root canal length measurement in the case where the leakage current is present.

Next, a case in which leakage current is generated in the root canal length measuring device, other than the case in which the strong electrolytic solution 117 exists in an area from the root canal orifice 116 to the gingiva 105, will be described below. First, as a case in which the leakage current is generated, there is a case in which the dental root is broken as shown in FIG. 23A and FIG. 23B (hereinafter also referred to simply as a fracture). However, the fracture which generates the leakage current is a fracture reaching the root canal, and a fracture to such an extent that only the superficial layer of a tooth cracks and does not reach the root canal is excluded.

FIG. 23A illustrates a sectional view of a tooth having the fracture in the vertical direction and part of a root canal length measuring device, and FIG. 23B illustrates a sectional view of a tooth in the horizontal direction at the fracture position. Generally, if fracture is present in the dental root, the alveolar bone at the place where the fracture occurs is absorbed or inflammation occurs. Although it can be treated by, e.g., bonding in the case of slight fracture, it is considered that a fractured tooth cannot be maintained and ordinarily it is extracted.

When the fracture 118 exists as shown in FIG. 23A, leakage current flows through the fracture 118, thereby adversely affecting the accuracy of root canal detection. If the leakage current from the fracture 118 is serious, it can be impossible to detect the apex accurately. Thus, to detect the apical position accurately, it is important to know existence of the fracture 118.

As another case in which the leakage current is generated, a collateral can be named. The collateral is an accessory root canal (collateral 119) which is branched from the root canal 107 (main root canal) as shown in FIG. 24. Usually, the collateral is difficult to be detected as in the case of the fracture and it is difficult to treat the collateral positively.

If the collateral 119 is present as shown in FIG. 24, the leakage current flows through the collateral 119, thereby adversely affecting the accuracy of root canal detection. If the leakage current from the collateral is serious, it can be impossible to detect the apex accurately. For the reason, to detect the apical position accurately, it is important to know existence of the collateral 119.

As a thing similar to the collateral, a perforation which is a through hole at a position different from the main root canal can be named. This perforation is formed when the root canal is dug by mistake in a direction departing from the main root canal mainly in expanding the root canal using a cutting tool. Thus, it may cause leakage current in the measurement of root canal length, like the collateral. Knowing existence of such a perforation, particularly a perforation at a position apart from the apex, is important in view of detecting the apical position accurately.

According to the Japanese Patent Application Laid-open No. 2000-5201, if leakage current is present in the measurement of root canal length, the leakage condition is compensated by the compensating means. However, in the Japanese Patent Application Laid-open No. 2000-5201, detection as to whether or not the leakage current is present, which is a premise for compensating for the leakage condition, is not performed.

Conventional diagnosis carried out for the fracture is a diagnosis with an X-ray picture or a microscope. However, the X-ray picture rarely allows to determine clearly whether or not any fracture exists and a portion which can be observed with a microscope is limited, and a portion covered with the gingiva or the apical portion is impossible principally to be diagnosed. Thus, many dentists experience a case in which treatment does not produce a favorable result despite repeated treatments and it is finally found that the fracture has been the cause therefor as a result of extracting the tooth by necessity. Thus, diagnostic equipment capable of indicating existence of the fracture without the necessity of extracting the tooth has been strongly demanded.

Likewise, conventional diagnosis for the collateral and perforation is a diagnosis based on an X-ray picture, and even the X-ray picture can rarely show existence of the collateral or the perforation. Accordingly, diagnostic equipment capable of indicating existence of the collateral or the perforation has been strongly demanded.

### SUMMARY OF THE INVENTION

An object of the present invention is to provide a dental diagnostic device capable of detecting to see whether or not an electric leakage path bypassing an apex of a tooth, that is, not passing through an apical foramen is contained in a conductive path, a root canal diagnostic device using the same, and a display unit for the same root canal treating apparatus and a dental diagnostic/treating table.

The dental diagnostic device of the present invention comprises: a measuring electrode to be inserted into a root canal of a tooth which is a measuring object; an oral electrode which is brought into an electric contact with mucosa; a measurement signal applying means for applying a measurement signal in between the measuring electrode and the oral electrode; and a measuring means for obtaining data corresponding to the electric characteristic of at least a part of a conductive path between the measuring electrode and the oral electrode based on measurement of an electric response to the measurement signal. This dental diagnostic device further comprises a detecting means for detecting whether or not an electric leakage path bypassing an apex of the tooth is contained in the conductive path by applying a predetermined determination standard to the data.

The dental diagnostic device of the present invention can detect whether or not an electric leakage path bypassing an apex of a tooth (not passing through the apical foramen) is contained in the conductive path and indicate existence of leakage of fluid from the root canal, a fracture or collateral by applying a predetermined determination standard to data corresponding to the electric characteristic of at least part of a conductive path between the measuring electrode and the oral electrode.

The root canal diagnostic apparatus of the present invention includes a dental diagnostic device having a detecting means for detecting whether or not an electric leakage path bypassing the apex of a tooth is contained in the conductive path as a component thereof.

The root canal treating apparatus of the present invention can progress treatment with diagnosis on the root canal thereby achieving effective treatment. That is, the same diagnosis as diagnosis using the aforementioned dental diagnostic device can be carried out on a stage prior to the treatment of the root canal or during the treatment of the root canal.

The display unit for the root canal diagnostic apparatus of the present invention includes a first display element and a second display element. The first display element mentioned here displays corresponding to a result of root canal length measurement from a root canal length measuring means for obtaining position information of a leading edge of the measuring electrode inserted into the root canal of a tooth within the root canal and the second display element displays according to a detection signal indicating that an electric leakage path not passing through the apical foramen exists between the measuring electrode and the oral electrode brought into an electric contact with the oral mucosa.

The display unit for the root canal diagnostic apparatus of the present invention make it possible to measure a root canal length while confirming presence or absence of a leakage current because it includes the first display element which indicates position information of a leading edge of a measuring electrode inserted into the root canal of a tooth within the root canal and the second display element which indicates that an electric leakage path not passing through the apical foramen.

The dental diagnostic/treating table of the present invention comprises at least one of the dental diagnostic device having a detecting means for detecting whether or not an electric leakage path bypassing the apex of a tooth is contained in a conductive path, a root canal diagnostic apparatus of the present invention and the display unit for the root canal diagnostic/treating apparatus of the present invention.

The dental diagnostic/treating table (dental diagnostic/treating unit) of the present invention comprises the dental diagnostic device of the present invention as well as ordinary diagnostic/treating table (dental diagnostic/treating unit) including a treatment table for holding a patient, a variety of diagnostic/treating devices for diagnosing or treating the patient, operation means for the diagnostic/treating devices, a spittoon for gargle and a display unit. Consequently, labor and time for carrying the patient or some apparatus for diagnosis can be eliminated thereby achieving effective diagnosis and treatment.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view for dental diagnosis (measurement of root canal length);

FIG. 2 is a schematic view of a case in which leakage of fluid is present in using a dental diagnostic device according to a first embodiment of the present invention;

FIG. 3 is a schematic view of a case in which fracture exists in using the dental diagnostic device according to the first embodiment of the present invention;

FIG. 4 is a schematic view of a case in which a collateral exists in using the dental diagnostic device according to the first embodiment of the present invention;

FIGS. 5 to 10 are schematic views of display sections of the dental diagnostic device according to the first embodiment of the present invention;

FIGS. 11 and 12 are diagrams showing equivalent circuits of a dental diagnostic device according to a second embodiment of the present invention;

FIG. 13 is a block diagram of the dental diagnostic device according to the second embodiment of the present invention;

FIG. 14 is a diagram showing a relationship between a distance from an apex and the capacitance of an element in a case where a fracture exists in using the dental diagnostic device according to the second embodiment of the present invention;

FIG. 15 is a diagram showing a relationship between a distance from an apex is present and the capacitance of the element in a case where leakage of fluid in using the dental diagnostic device according to the second embodiment of the present invention;

FIG. 16 is a diagram showing an equivalent circuit of a dental diagnostic device according to a third embodiment of the present invention;

FIG. 17 is a diagram showing a relationship between a distance from an apex and the capacitance of an element in a case where leakage of fluid is present in using the dental diagnostic device according to the third embodiment of the present invention;

FIG. 18 is a schematic view of a root canal diagnostic apparatus according to a fourth embodiment of the present invention;

FIG. 19 is a schematic view of a dental diagnostic/treating table according to the fourth embodiment of the present invention;

FIG. 20 is a sectional view for describing the structure of a tooth;

FIG. 21 is a schematic view of a conventional root canal length measuring device;

FIG. 22 is a schematic view of a case in which leakage of fluid is present in using the conventional root canal length measuring device;

FIGS. 23A and 23B are schematic views of a case in which a fracture is present in using the conventional root canal length measuring device; and

FIG. 24 is a schematic view of a case in which a collateral is present in using the conventional root canal length measuring device.

### DESCRIPTION OF THE PREFERRED EMBODIMENTS

### First Embodiment

### <Summary>

The dental diagnostic device according to this embodiment obtains data corresponding to impedance of a predetermined area based on measurement of an electric response to a measurement signal applied between a measuring electrode inserted into a root canal and an oral electrode brought into electric contact with oral mucosa as an electric characteristic of a conductive path between these electrodes, and detects presence or absence of an electric leaking path (excluding a path providing a slight electric leakage which does not affect the measurement) departing from a conductive path in the root canal which is a main conductive path. The data based on an electric response may be an electric response itself or a combination of a plurality of electric responses.

For example, if the electric characteristic obtained from the electric response is assumed to be an impedance value, that data may be an impedance value itself between the measuring electrode and the oral electrode brought into electric contact with the oral mucosa or a value obtained through arithmetic operation of a plurality of impedance values (ratio, difference, arithmetic operation result substantially equal to a ratio or difference obtained through logarithmic arithmetic operation, and so on) or a table value read from the impedance value.

The electric leaking path is a current path that does not pass through an apical foramen, such as a fractured portion, a collateral and a leaking portion due to leakage of fluid. This embodiment is constructed to indicate presence or absence of electric leaking path visually or acoustically, and as a preferred example, when the existence of an electric leaking path is detected, it is displayed as a warning visually or acoustically.

The characteristic value of an electric path as a measurement object may be a characteristic value of part of the electric path (for example, only capacitive component) as will be described later in a second embodiment or an impedance value of the entire electric path in the first embodiment.

### <Configuration and Operation>

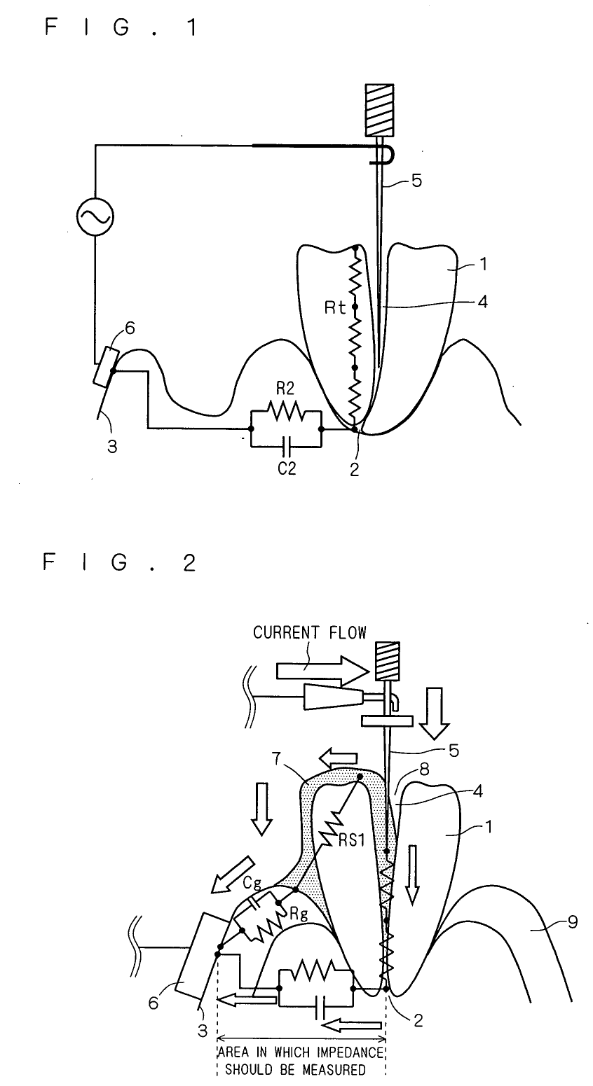

More specifically, a dental diagnostic device for detecting presence or absence of an electric leaking path using a ratio of an impedance value between a measuring electrode and an oral electrode brought into electric contact with oral mucosa, measured with a plurality of frequencies, will be described below in detail. First, the measurement principle of the root canal length measuring device (dental diagnostic device) for measuring and detecting the ratio of impedance values will be described based on a schematic circuit configuration of FIG. 1.

In this configuration, an equivalent circuit in which resistance of a current path within a root canal 4 is set to resistance Rt, and a current path from an apex 2 to oral mucosa 3 is a parallel circuit having a capacitance C2 and a resistance R2 (the impedance value is of substantially a constant value (6.5 kΩ) without difference depending on ages or tooth types) is assumed. The resistance element Rt in the root canal is connected to this parallel circuit in series. However, the aforementioned equivalent circuit is an example and the equivalent circuit for use in the present invention is not limited to the equivalent circuit shown in FIG. 1. The RC parallel type equivalent circuit of FIG. 1 has been widely recognized and it is preferable to assume an equivalent circuit based on this formation.

To detect the position of the apex 2 accurately in measurement of the root canal length with the schematic configuration shown in FIG. 1, substantially all measuring current from a measuring electrode 5 inserted into the root canal 4 needs to flow into an oral electrode 6 from the root canal 4 through the apex 2. Although according to this embodiment, the impedance value between the measuring electrode 5 and the oral electrode 6 (hereinafter referred to as a “measuring object portion”) is measured by detecting a measuring current, the impedance value of the measuring object portion may be calculated with a voltage on both ends of a detecting resistance (see FIG. 11) in a detecting circuit or a resistance value obtained when some current or voltage is provided used as a measurement index.

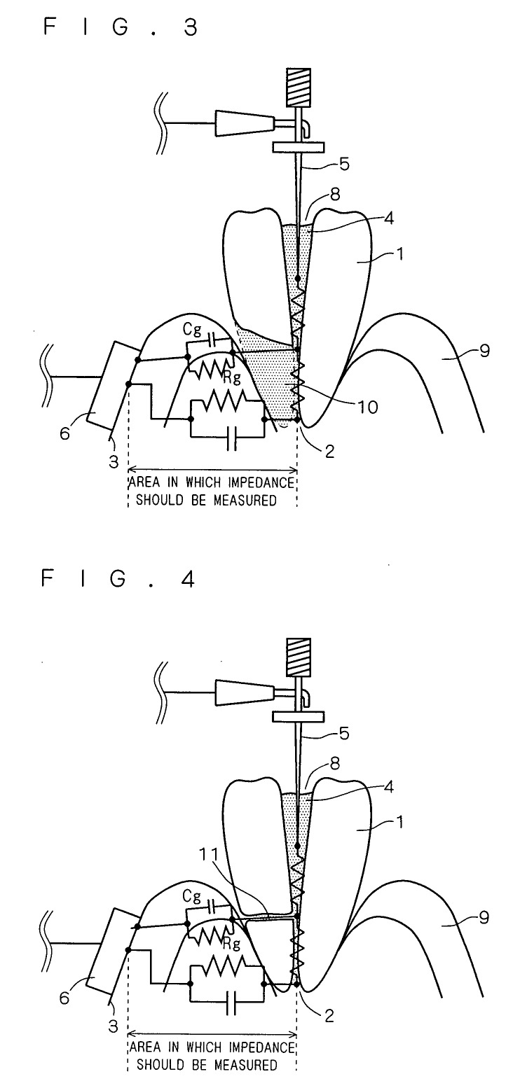

In actual clinical conditions, as shown in FIG. 2, an electric leaking path from a root canal orifice 8 to gingiva 9 along the surface of a tooth 1 can be present due to a strong electrolytic solution 7 such as bleeding, exudate, or an excellent conductive chemical in the root canal. In this electric leaking path, it can be considered that an equivalent circuit in which, with a resistance of a path from the root canal orifice 8 to the gingiva 9 as a resistance Rs1, the impedance from the gingiva 9 to the oral electrode 6 is determined by a parallel circuit having a capacitance Cg and a resistance Rg is connected to the equivalent circuit of FIG. 1 as a bypass circuit.

That is, the equivalent circuit in the case where a leakage current from the root canal orifice 8 is present is a parallel circuit configured by, as shown in FIG. 2, a main conductive path passing through the root canal 4 to the apex 2 and a bypass path in parallel to the main conductive path. However, this equivalent circuit is an example and the equivalent circuit for use in the present invention is not limited to the equivalent circuit shown in FIG. 2.

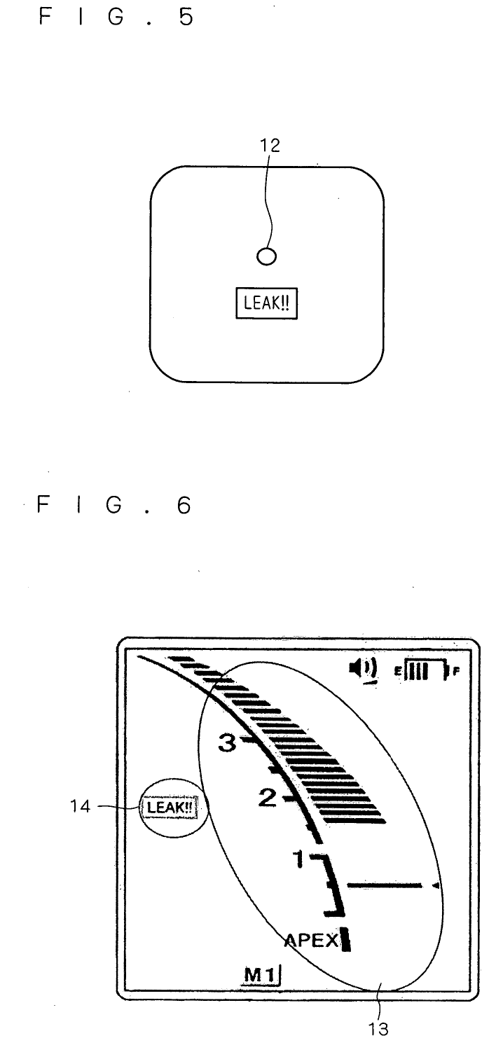

As well as the electric leaking path due to the strong electrolytic solution 7, an electric leaking path due to a fracture 10 shown in FIG. 3 or an electric leaking path due to a collateral 11 shown in FIG. 4 sometimes exists. In the equivalent circuit shown in FIG. 3, it can be considered that an equivalent circuit in which an area from the generation portion of the fracture 10 to the oral electrode 6 is formed as a parallel circuit configured by the capacitance Cg and the resistance Rg, and is connected as a bypass path to the equivalent circuit of FIG. 1 in parallel. Likewise, in the equivalent circuit shown in FIG. 4, it can be considered that the equivalent circuit in which an area from the generation portion of the collateral 11 up to the oral electrode 6 is formed as a parallel circuit configured by the capacitance Cg and the resistance Rg, and is connected as a bypass path to the equivalent circuit of FIG. 1 in parallel. However, that equivalent circuit is an example and the equivalent circuit for use in the present invention is not limited to the equivalent circuit shown in FIGS. 3 and 4.

In a case of a configuration in which the electric leaking path is not present as shown in FIG. 1, the ratio of impedance values obtained by measuring a measuring current corresponding to measurement signals each having a different frequency substantially reaches a predetermined threshold set in that apparatus when the measuring electrode 5 reaches the apex 2. This has been disclosed in Japanese Patent No. 2873722.

However, in the configuration where a change of the ratio of the impedance values described above increases as the measuring electrode 5 approaches the apex 2 and if a measurement environment has a bypass path as shown in FIGS. 2 to 4, sometimes the aforementioned predetermined threshold is attained or exceeded before the measuring electrode 5 reaches the apex 2. Depending on circumstances, the predetermined threshold is attained or exceeded at the moment when the measuring electrode 5 is inserted into the root canal 4. To the contrary, if the denominator and numerator of a formula for calculating the ratio of the impedance values are replaced with each other, the ratio of the impedance values decreases as the measuring electrode 5 approaches the apex 2, and if the measuring environment has a bypass path as shown in FIGS. 2 to 4, the change of the ratio of the impedance values can be equal to or lower than the aforementioned predetermined threshold before the measuring electrode 5 reaches the apex 2.

Hereinafter, description below is made about a configuration in which the change of the ratio of the impedance value increases as the measuring electrode 5 approaches the apex 2. If the latter configuration in which the change of the ratio of the impedance values decreases as the measuring electrode 5 approaches the apex 2 is adopted, needless to say, description below of “equal to or larger than a predetermined threshold” and “larger than a predetermined threshold” is read as “equal to or smaller than a predetermined threshold” and “smaller than a predetermined threshold”.

In a case of the configuration having a bypass path shown in FIGS. 2 to 4, the capacitance Cg which is a circuit element of the equivalent circuit of the bypass circuit increases extremely, so that the ratio of the impedance values becomes equal to or larger than the predetermined threshold due to an influence of the capacitance Cg before the measuring electrode 5 reaches the apex 2. Thus, whether or not any electric leaking path exists can be detected by measuring to see whether or not the ratio of the impedance values increases by a predetermined amount (determination margin) or more with respect to a predetermined threshold indicating the apex 2. The determination margin should be determined corresponding to the characteristic of the device, and for example, may be 25% of the predetermined threshold indicating the apex 2.

If the ratio of the impedance values increases by the determination margin or more with respect to the predetermined threshold, it is regarded that an electric leaking path exists in the dental diagnostic device according to this embodiment, so that a warning is indicated to an operator (dentist) about the existence of leakage current. This indication of warning can be carried out by providing a light emission means such as an LED inside or outside the root canal length measuring device and by lighting it. The example of the warning indication shown in FIG. 5 shows a warning indicator provided separately from the root canal length measuring device, and an LED 12 is lit when a leakage current is present.

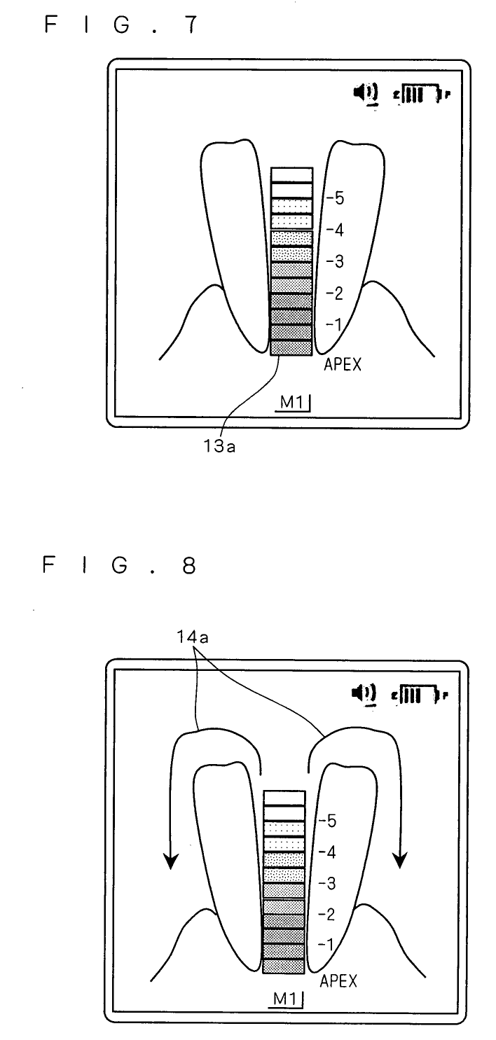

FIG. 6 shows an example in which a leakage indication 14 for indicating presence/absence of a leakage current (more specifically, indication lit only when a leakage current is found) is added to the indication surface of a meter indication 13 for root canal length measurement (more specifically, as the leading edge of the measuring electrode 5 approaches the apex 2, the quantity of lit dots is increased from dots located at the top in FIG. 6 in succession and when it is determined that the leading edge of the measuring electrode 5 reaches the apex 2, dots up to a dot located at the position indicating APEX is lit). Conventionally, a dentist cannot easily see whether or not a leakage current is present; however, the indication shown in FIGS. 5 and 6 is capable of indicating the possibility that a leakage current is present, so that the dentist can easily recognize the possibility that an error due to the leakage may exist at the time of root canal length measurement.

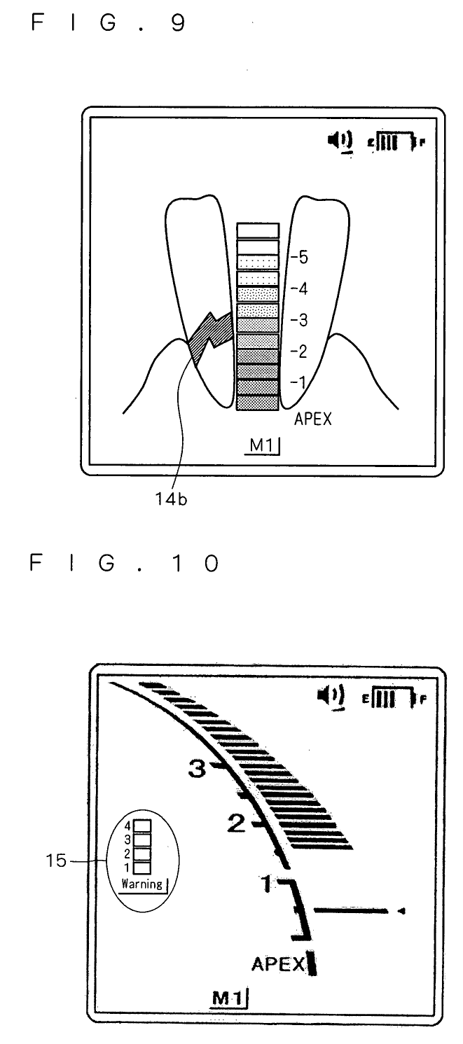

As another examples of the indication shown in FIG. 6, for example, indication using a tooth schematic view as shown in FIGS. 7 to 9 is possible. A meter indication 13a for root canal measurement may be provided on the tooth schematic view as shown in FIG. 7, and further, the presence/absence of leakage current may be represented schematically with a leakage indication 14a as leakage of fluid from the root canal orifice, as shown in FIG. 8. Further, if the leakage current is present, it can be regarded that a fracture or a collateral can exist and then, the fracture or collateral may be represented schematically with a leakage indication 14b by superimposing it on the tooth schematic view as shown in FIG. 9.

More specifically, at the beginning, the existence of a leakage current is regarded as leakage of fluid from the root canal orifice and the leakage indication 14a is displayed as shown in FIG. 8, and it is memorized that the leakage of fluid is eliminated by cleaning and wiping of the root canal orifice, into the dental diagnostic device by operator's pressing an operation switch (not shown). Further, it is permissible to adopt an example of a configuration for indication switching in which when the leakage current is again detected in that condition, it is regarded that a fracture or collateral exists and the leakage indication 14b is displayed as shown in FIG. 9. With the configuration which indicates the result of root canal length measurement and presence/absence of the leakage current using the tooth schematic view, the operator can grasp the condition within the root canal visually, which is convenient.

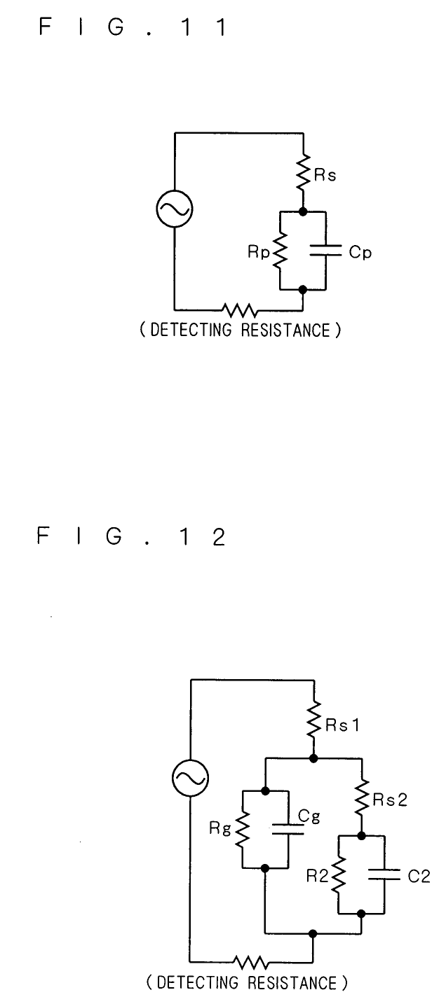

Preferably, as shown in FIG. 10, the magnitude of the leakage current may be displayed visually at divided stages using a level meter 15 capable of comparing the magnitudes of the leakage current in a sensory manner as well as determining the presence/absence of the leakage current. If the ratio of the impedance values becomes equal to or larger than a predetermined threshold indicating the apex, the conventional root canal length measuring device makes indication by substantially swinging off the meter indication 13 for root canal length measurement. However, if the ratio of the impedance values becomes equal to or larger than the predetermined threshold indicating the apex, a magnitude of leakage is displayed on the level meter 15 indicating the magnitude of the leakage, in the dental diagnostic device having a display section shown in FIG. 10.

The level meter 15 may be configured to indicate the quantity of the leakage current in a stepwise fashion as shown in FIG. 10 or may be configured to indicate the quantity of the leakage current continuously like an analog meter. The indication of the leakage current in the present invention may be performed with the level meter 15 separated from the meter indication 13 for root canal length measurement shown in FIG. 10, or may be performed by integrating with the meter indication 13 for root canal length measurement. Further, the quantity of the leakage current may be indicated schematically by changing the density, color, or size of each leakage indication by applying the leakage indications 14a and 14b shown in FIGS. 8 and 9. Further, the warning indication about the existence of electric leaking path (presence/absence of leakage current) in the present invention may not only be carried out with visual indication but also with acoustic indication using a buzzer or speaker independently or in combination. In that case, it is easy for the dentist to grasp the level of the leakage current in a sensory manner by raising the sound volume of the acoustic indication as the leakage increases, or, if a configuration which makes acoustic indication by making a sound intermittently is provided by narrowing intervals of the acoustic indication as the quantity of the leakage current increases.

If the leakage current is present, the conventional root canal length measuring device sometimes indicated an apical instruction value even when the measuring electrode did not reach the apex. Particularly, if the root canal enlarging device and the root canal length measuring device operate in conjunction with each other, when the leading edge of the root canal enlarging file reaches the apex, it is controlled to stop the root canal enlargement work or reduce output for the root canal enlargement. Thus, in the root canal enlarging device which operates in conjunction with the conventional root canal length measuring device, if any leakage current is present, the root canal enlargement work is stopped or output-reduced at an erroneous position, so that effective root canal enlargement is impossible. Because this embodiment can distinguish erroneous detection due to the leakage current from an accurate detection of the apex, the root canal enlarging device can be controlled more accurately. The function according to this embodiment is a particularly useful for the root canal length measuring device which operates in conjunction with the root canal enlarging device.

In this case, even if a result of the root canal length measurement indicates an apical position by mistake due to the leakage current before the apex is reached and correspondingly, the root canal enlarging device is stopped or its output is dropped, the dentist can see the existence of the leakage current through an indication signal indicative of detection of the existence of the leakage current, so that the dentist can determine whether the stop of the root canal enlarging device or the drop of the output is caused by reaching of the apex or the existence of the leakage current, thereby improving convenience. The stop of the root canal enlargement work includes not only the stop of a drive unit but also inversion of a rotation direction in the case where the drive unit is a motor. The drop of the output of the root canal enlarging device includes, in the case where the drive unit is a motor, reduction of the rotation speed and repeating of forward rotation and backward rotation alternately.

A configuration of the apparatus for achieving the foregoing can be understood from description mainly on a different portion from the circuit configuration in a second embodiment described later with reference to the circuit configuration (FIG. 13) of the second embodiment. That is, according to the first embodiment, of three oscillators 20, 21, 22 in the circuit configuration of FIG. 13, only two oscillators 20, 21 are provided. Then, in an arithmetic circuit provided in the first embodiment corresponding to the arithmetic circuit 28 of FIG. 13, each measuring current measured with two frequencies is inputted from an A-D converter 27 successively and a ratio of impedance values is calculated based thereon. Calculation of the ratio of the impedance values in this arithmetic circuit can be performed based on the configuration disclosed in Japanese Patent No. 2873722. The ratio of impedance values specified in this way is compared with a threshold registered in the arithmetic circuit preliminarily and when the ratio of the impedance values exceeds the threshold, a warning indication instruction signal is outputted to a display section 29. When the determination margin is taken into account, the value of the determination margin is registered in the arithmetic circuit. In the case of stepwise indication of the leakage current or continuous indication thereof, an indication instruction signal corresponding thereto is outputted to the display section 29, so that an indication corresponding thereto is carried out.

### Second Embodiment

### <Summary>

In the dental diagnostic device according to this embodiment, the electric configuration between the measuring electrode and oral mucosa (oral electrode) is regarded as an equivalent circuit configured by a resistance Rs, resistance Rp and capacitance Cp shown in FIG. 11, and electric characteristic values of elements constituting the equivalent circuit are obtained from the impedance values between the measuring electrode and the oral mucosa detected using detecting resistance so as to detect the presence or absence of leakage current based on the magnitude of the electric characteristic values of the elements. In the meantime, the dental diagnostic device according to this embodiment indicates the presence or absence of leakage current and can also detect an abnormality in the shape of a tooth such as a fracture or a collateral by measuring the presence or absence of the leakage current with no leakage of strong electrolytic solution from the root canal orifice ensured.

The equivalent circuit shown in FIG. 11 is an example and the present invention is not limited to the equivalent circuit shown in FIG. 11. The present invention does not always require absolute measurement of the electric characteristic values of the elements of the equivalent circuit and numeric values indicating the magnitude of the electric characteristic values and the threshold indicating the presence or absence of leakage current vary depending on the circuit configuration adopted by the measurement system. In any case, the present invention mainly aims at detecting the presence or absence of electric leakage by replacing an electric path between the measuring electrode and the oral electrode with some equivalent circuit and then taking the elements of the equivalent circuit as a measuring object.

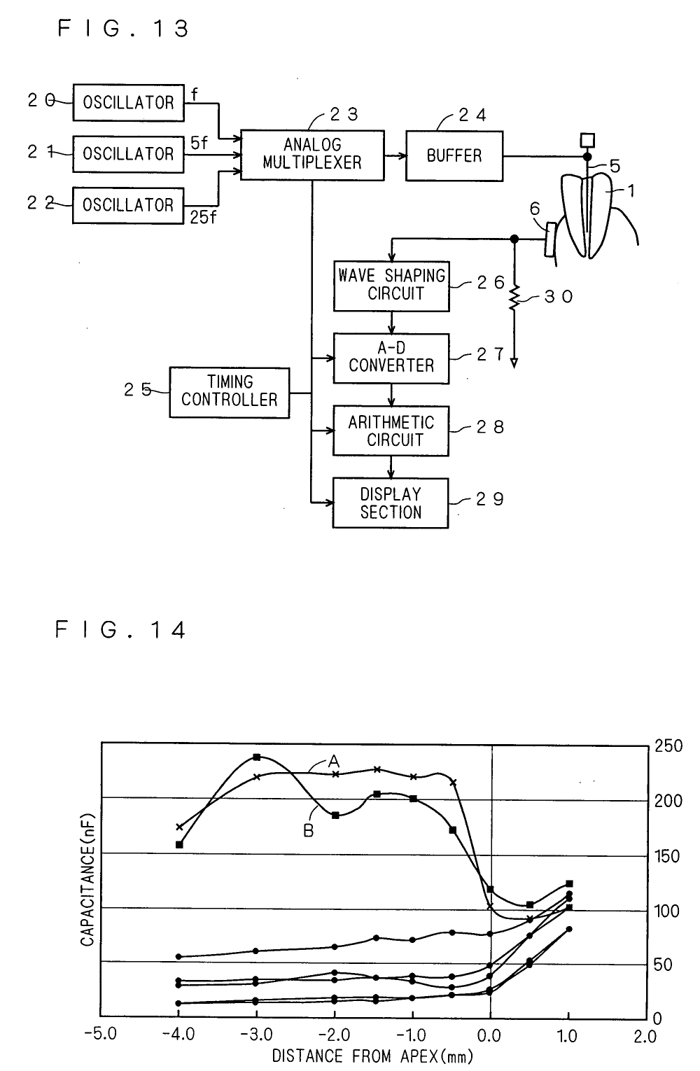

In the dental diagnostic device according to this embodiment, the equivalent circuit between the measuring electrode and oral mucosa is assumed to be in the form of an equivalent circuit shown in FIG. 11 even if a leakage current is present. That is, it is approximated that the capacitance Cg and the resistance Rg contained in the equivalent circuit of the bypass path in FIGS. 2 to 4 are included in the capacitance Cp and the resistance Rp shown in FIG. 11. More specifically, the circuit diagram of the equivalent circuit in FIGS. 2 to 4 can be originally expressed as a combination of a plurality of resistances and capacitances as shown in FIG. 12, and in this embodiment, by approximating resistances Rs1, Rs2 in FIG. 12 to a resistance Rs in FIG. 11, resistances Rg, R2 in FIG. 12 to a resistance Rp in FIG. 11 and capacitances Cg, C2 in FIG. 12 to a capacitance Cp in FIG. 11, the equivalent circuit of FIG. 11 is used (the present invention is not limited to this equivalent circuit).

The equivalent circuit of FIG. 11 is not so high in accuracy as an equivalent circuit to indicate electric characteristics of a root canal in the case where a leakage current exists. However, for the purpose of detecting whether or not a leakage current exists, an excellent result can be obtained even if the equivalent circuit of FIG. 11 is used. As regards the accuracy of apex detection in the technical field which the present invention belongs to, if the root canal length measuring device can indicate an apical position when the leading edge of the measuring electrode 5 is in a range of up to about 1.5 mm in front of the apex 2, it is sometimes regarded that root canal length measurement without any problem in term of actual clinical conditions is performed and a measurement allowance to some extent is permitted. Particularly, one of objects of the present invention is to detect whether or not such a leakage current as to affect the apex detection accuracy exists or whether or not a leakage current due to a fracture or collateral exists, but not to obtain the value of the leakage current accurately. Therefore, a sufficiently excellent result can be obtained if the equivalent circuit of FIG. 11 is adopted. In the meantime, the present invention is not limited to the equivalent circuit of FIG. 11, but any equivalent circuit which produces no problem clinically or practically may be selected appropriately. The detecting resistance in FIGS. 11 and 12 is not an element of the equivalent circuit and provided within the detecting circuit for detecting impedance of the equivalent circuit.

Hereinafter, the dental diagnostic device according to this embodiment using the equivalent circuit in FIG. 11 will be described. The equivalent circuit of FIG. 11 includes three elements, i.e., a resistance Rs, a resistance Rp and a capacitance Cp. If no leakage current exists in the equivalent circuit of FIG. 11, of the respective elements of this equivalent circuit, the resistance Rs corresponds to a resistance between the measuring electrode and periodontal membrane and a parallel circuit of the resistance Rp and the capacitance Cp corresponds to impedance between the periodontal membrane and the oral mucosa.

However, if a leakage current is present in the equivalent circuit of FIG. 11, the parallel circuit of the resistance Rp and the capacitance Cp includes both the impedance between the periodontal membrane and the oral mucosa (main conductive path) and impedance of a path of the leakage current (bypass path). However, the present invention concerns diagnosis of living body and the equivalent circuit shown in FIG. 11 is not exactly equivalent but sufficient for detection of the presence or absence of a leakage current.

The dental diagnostic device according to this embodiment detects the existence of any electric leaking path depending on change in values of the elements Rs, Rp, Cp of the equivalent circuit. For example, the presence/absence of a leakage current from a root canal orifice or the presence/absence of a leakage current due to existence of abnormality in the shape of a tooth such as a fracture and a collateral can be detected by detecting a difference between the capacitance Cp in the case where no leakage current is present and the capacitance Cp in the case where a leakage current is present. Further, the dental diagnostic device according to this embodiment can indicate the change in capacitance Cp as change in quantity of the leakage current by adopting the indication in FIG. 10 and the like. The level of the leakage current or the effect of cleaning/wiping to reduce the leakage current will be made evident by this indication.

### <Outline of Operation>

Next, the operation of the dental diagnostic device according to this embodiment will be described. FIG. 13 shows a block diagram of the dental diagnostic device according to this embodiment. The dental diagnostic device shown in FIG. 13 includes three oscillators each capable of generating a measurement signal having a different frequency, that is, an oscillator 20 for outputting a measurement signal having a frequency f, an oscillator 21 for outputting a measurement signal having a frequency 5f (five times f) and an oscillator 22 for outputting a measurement signal having a frequency 25f (25 times f), by utilizing the fact that electric response due to impedance having a capacitive component has frequency dependency. Because this embodiment includes three types of the elements in the equivalent circuit shown in FIG. 11, three kinds of measurement frequencies are required to solve simultaneous equations representing the impedance of the equivalent circuit to be described later. Although this embodiment uses one time, five times, 25 times the basic frequency f (that is, basic frequency and its harmonics) as a plurality of frequencies for use, the present invention is not limited to this, but may use one time, ten times or 100 times the basic frequency and so on.

The dental diagnostic device shown in FIG. 13 is equipped with an analog multiplexer 23, a buffer 24, and a timing controller 25. Further, the dental diagnostic device shown in FIG. 13 is provided with a wave shaping circuit 26, an A-D converter 27, an arithmetic circuit 28, a display section 29 and a detection resistance 30. The timing controller 25 is for controlling timing of the operation of each circuit and the analog multiplexer 23 switches output of the oscillators 20, 21, 22 based on that control per, e.g., 10 msec. Then, the output from the analog multiplexer 23 is applied to the measuring electrode 5 through the buffer 24.

In this embodiment, as described in relation to the background art, a change in the measurement current is detected as a change in the impedance between the measuring electrode and the oral mucosa. Thus, the change in the impedance between the measuring electrode and the oral mucosa at each frequency of the measurement signal is detected as a measurement current by the detecting resistance 30. After this measurement current is rectified by the wave shaping circuit 26 into a shaped waveform, it is converted to digital data by the A-D converter 27.

Further, the arithmetic circuit 28 obtains a value corresponding to a resistance value of the resistance Rs, a value corresponding to a resistance value of the resistance Rp and a value corresponding to a capacitance value of the capacitance Cp by arithmetic operation from an impedance value between the measuring electrode and the oral mucosa measured successively at frequencies f, 5f, 25f while the digital data from the A-D converter 27 is latched each time. Although the measurement of the impedance value is desirably carried out at the frequencies f, 5f and 25f at a substantially identical position in the root canal of the measuring electrode 5, the switching speed of the frequencies f, 5f, 25f does not affect the detection of leakage current because it is faster than the insertion speed of the measuring electrode 11 even if the position of the measuring electrode 5 is not always strictly identical.

According to this embodiment, a value corresponding to the capacitance value of the capacitance Cp is handled as data corresponding to the electric characteristic of the root canal and that data is used as a parameter which indicates the presence/absence of leakage current, particularly the magnitude of the leakage current. The arithmetic circuit 28 includes a comparator (or a program which achieves a comparison function in terms of software) internally and when a predetermined threshold memorized preliminarily is compared with this data value and that data value is over the predetermined threshold, that is, a value (including the capacitance value of the capacitance Cp itself) corresponding to the capacitance value of the capacitance Cp is over a predetermined threshold, existence of a leakage current is indicated on the display section shown in FIG. 5 or FIGS. 6 to 9. As in the display section shown in FIG. 10, its warning indication may be changed corresponding to the capacitance value. Of course, the indication is not limited to visual indications but it is permissible to indicate a warning acoustically using a buzzer or a speaker.

To indicate the leakage current in a stepwise fashion, a plurality of thresholds (final threshold and indication threshold at halfway stage) are set as the aforementioned threshold and its indication stage is raised each time the data value exceeds each threshold. A single threshold is permitted in the case of continuous indication. In the second embodiment also, a determination margin may be used for comparison with the threshold for determination.

When the dentist recognizes existence of a leakage current using the dental diagnostic device according to this embodiment, he or she performs treatment for preventing leakage of strong electrolytic solution from the root canal orifice. In the case where the indication suggesting the existence of leakage current does not disappear despite this treatment, consequently, the existence of a fracture or a collateral is suspected. That is, although conventionally, the existence of a fracture or a collateral can only diagnosed vaguely, use of the dental diagnostic device according to this embodiment enables existence of abnormality in the shape of a tooth such as a fracture and a collateral to be diagnosed with some degree of certainty.

### <Detailed Operation of Arithmetic Circuit>

Next, the operation of the arithmetic circuit 28 according to this embodiment will be described in detail. First, the arithmetic circuit 28 is provided with an equivalent circuit in which a conductive path between the measuring electrode and the oral mucosa is modeled. In this embodiment, this equivalent circuit is constructed in the form of the equivalent circuit shown in FIG. 11. The equivalent circuit shown in FIG. 11 can represent the impedance with an equation of Rs+Rp//Cp. The symbol “//” in the equation indicates a synthetic resistance in parallel connection.

Then, assume that the resistance value of the resistance Rs is Rsv, the resistance value of the resistance Rp is Rpv and the capacitance value of the capacitance Cp is Cpv. When the frequency of the measurement signal is f, 5f, 25f, each impedance value of the capacitance Cp is 1/(2πfCpv), 1/(10πfCpv) and 1/(50πfCpv). In this embodiment, the impedance is approximated to 1/(jωCpv)=1/(ωCpv) for simplification (angular frequency ω=2π×frequency).

The impedance value of the frequency f can be calculated according to an equation 1 using these values.

$$Impedance value of equivalent circuit having a frequency f = Rsv + Rpv // \frac{1}{2 π fCpv} = Rsv + \frac{Rpv \times \frac{1}{2 π fCpv}}{Rpv + \frac{1}{2 π fCpv}} = Rsv + \frac{Rpv}{Rpv \times 2 π fCpv + 1} \qquad [ Equation 1 ]$$

Likewise, the impedance of the frequency 5f can be calculated according to an equation 2.

$$Impedance value of equivalent circuit having a frequency 5 f = Rsv + \frac{Rpv}{Rpv \times 10 π fCpv + 1} \qquad [ Equation 2 ]$$

Likewise, the impedance value of the frequency 25f can be calculated according to an equation 3.

$$Impedance value of equivalent circuit having a frequency 25 f = Rsv + \frac{Rpv}{Rpv \times 50 π fCpv + 1} \qquad [ Equation 3 ]$$

In the arithmetic circuit 28, impedance values between the measuring electrode and the oral mucosa measured at the frequencies f, 5f, 25f are inputted to the above-described equations each time and by solving the simultaneous equations of equations 1 to 3, the resistance value Rsv, resistance value Rpv and capacitance value Cpv can be obtained.

That is, the arithmetic circuit 28 is capable of obtaining values of the elements (resistance Rs, resistance Rp, and capacitance Cp) of an equivalent circuit at a position in which the leading edge of the measuring electrode exists.

As a more simple way, it is permissible to obtain and memorize in a table in the arithmetic circuit 28 the elements Rs, Rp, Cp through calculation in advance by combining the impedance values between the measuring electrode and the oral mucosa measured at the frequencies f, 5f, 25f, and introduce a value of an element (for example, capacitance Cp) from the respective impedance values obtained from the tooth 1 of a measurement object. The table may be provided within the arithmetic circuit 28 or in an external memory section. To suppress the quantity of data to be memorized in the table, data may be memorized discretely and interpolation processing may be used. Further, as the data to be stored in the table, a value to be indicated on the display section or presence/absence of warning indication may be stored instead of the values of the elements Rs, Rp and Cp.

As described above, in the dental diagnostic device according to this embodiment, the impedance value between the measuring electrode and the oral mucosa at each frequency for measurement is obtained and a predetermined processing is carried out to detect existence of an electric leaking path from changes in the values of the elements Rs, Rp, and Cp of the equivalent circuit.

### SPECIFIC EXAMPLES

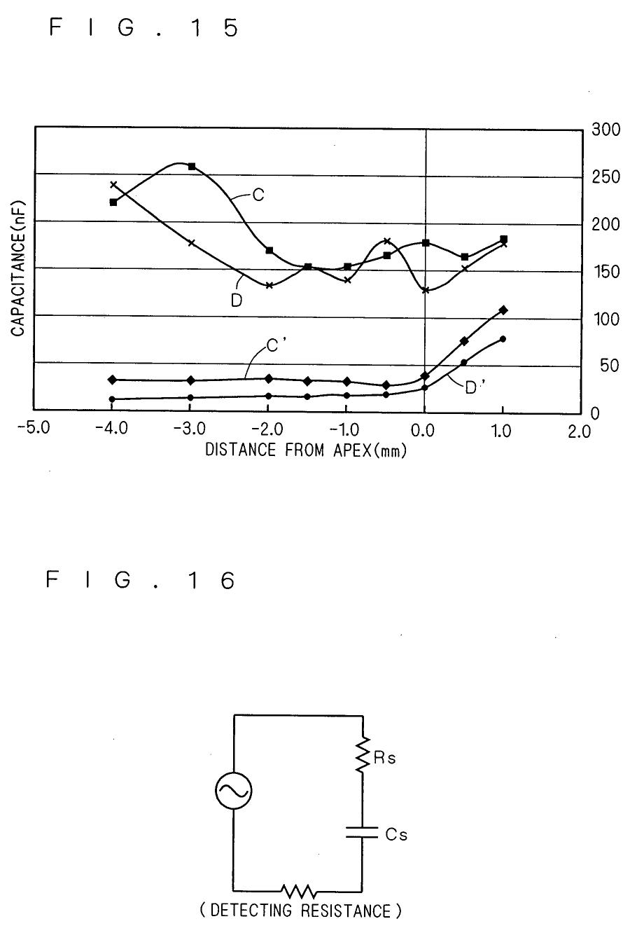

FIG. 14 shows a diagram in which the capacitance values of the element Cp of each tooth obtained with the dental diagnostic device according to this embodiment are plotted. The abscissa axis of FIG. 14 indicates a distance from an apex at the leading edge of the measuring electrode 5 (unit: mm) and the ordinate axis of FIG. 14 indicates the capacitance value of the element Cp in the unit of nano Farad. The graph of FIG. 14 was produced by obtaining the impedance values between the measuring electrode and the oral mucosa with an impedance meter through experiment and calculating capacitance values from actually measured impedance values. However, in the dental diagnostic device actually implementing the present invention, it is permissible to use other quantity having a correlation with the impedance values instead of measuring the impedance values actually and set a threshold for detecting of a leakage current corresponding thereto.

As for the graphs shown in FIG. 14, in the case of graphs A and B, the capacitance value of their element Cp is large because they indicate a tooth having a fracture while in the case of other graphs, the capacitance value of the element Cp is small because they indicate a tooth having no fracture. It is evident from the graphs of FIG. 14 that a value corresponding to the capacitance value of the element Cp differs between the tooth having a fracture and the tooth having no fracture. Thus, the dental diagnostic device according to this embodiment can detect existence of a fracture by applying a predetermined determination standard to a value corresponding to the capacitance value of the element Cp. As the predetermined determination standard for detecting the existence of a fracture (presence/absence of leakage current), a case of directly comparing a value corresponding to the capacitance value of the element Cp with a reference value which serves as a threshold, a case of obtaining a ratio between a value corresponding to the capacitance value and the reference value, a case of obtaining a difference between a value corresponding to the capacitance value and the reference value, a case of performing the same arithmetic operation for substantially obtaining a ratio or a difference by logarithmic arithmetic operation and the like can be considered. Further, the existence of a fracture (presence/absence of leakage current) can be detected by comparing the degree of change in capacitance value Cp corresponding to the change in position from the apex, with the degree of standard change memorized preliminarily, using the degree of change as a reference value, instead of comparing the capacitance value of the element Cp with a reference value.

In the graphs A and B shown in FIG. 14, values corresponding to the capacitance value of the element Cp indicates a predetermined threshold (for example, 100) or more from the moment when the measuring electrode is inserted into the root canal, thereby indicating that a fracture is present. In this embodiment also, the degree of abnormality may be indicated on the level meter 15 as shown in FIG. 10 corresponding to a value corresponding to the capacitance value of the element Cp.

Likewise, FIG. 15 shows a diagram in which capacitance values of the element Cp in a tooth having no fracture are plotted. Graphs C and D in the graphs shown in FIG. 15 indicate a case where leakage of strong electrolytic solution from the root canal orifice is present, and graphs C′ and D′ indicate a case where no leakage of strong electrolytic solution from the root canal orifice of the same tooth is present. In the graph of FIG. 15, values corresponding to the capacitance value of the element Cp differ clearly depending on whether leakage of strong electrolytic solution is present or absent. For the reason, the dental diagnostic device according to this embodiment can detect existence of leakage of strong electrolytic solution, that is, presence/absence of leakage current from the root canal orifice by applying a predetermined determination standard to a value corresponding to the capacitance value of the element Cp, so that the dentist can perform appropriate treatment such as cleaning and wiping of the root canal orifice. It is evident from the above-described result that the dental diagnostic device according to this embodiment can detect existence of a collateral in a tooth.

### Third Embodiment

### <Summary>

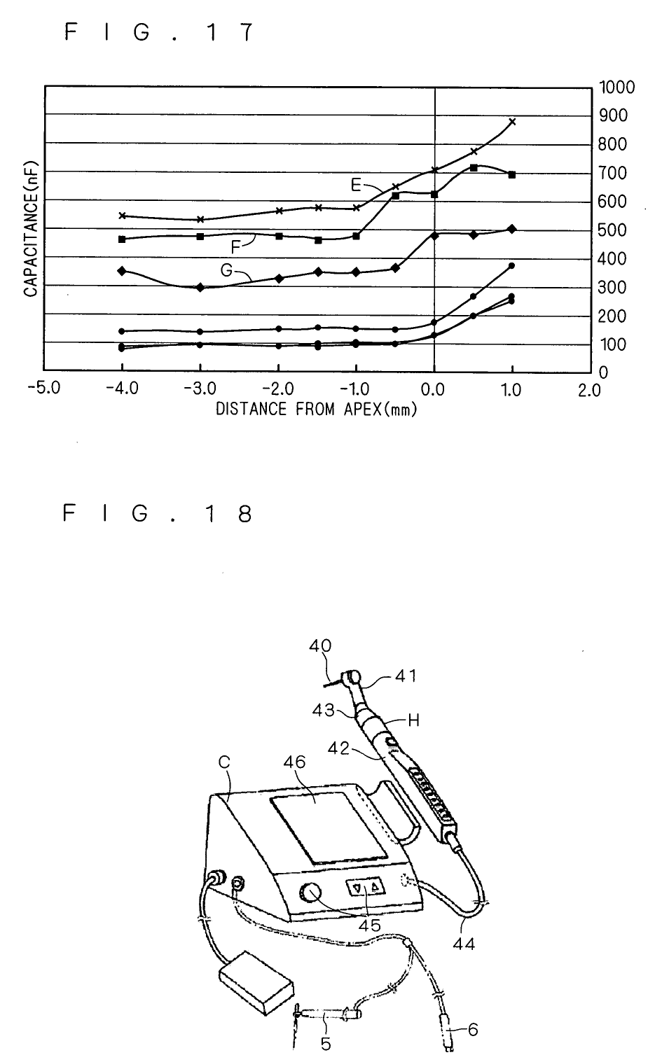

Although in the second embodiment, the impedance value between the measuring electrode and the oral mucosa including a bypass path is regarded as the equivalent circuit shown in FIG. 11, in this embodiment, it is regarded as an equivalent circuit shown in FIG. 16. The equivalent circuit shown in FIG. 16 has a structure in which the parallel circuit portion configured by the resistance Rp and the capacitance Cp in FIG. 11 is replaced with a capacitance Cs. Although the equivalent circuit shown in FIG. 16 is constituted by further approximating the equivalent circuit shown in FIG. 12 in comparison with the one of FIG. 11, use of this equivalent circuit also enables the existence of an electric leaking path (presence/absence of leakage current) to be detected as in the second embodiment.

The measurement of impedance value in this embodiment is carried out by measuring a current and the like with a detecting resistance provided in the detecting circuit. The equivalent circuit shown in FIG. 16 is an example and the present invention is not limited to the equivalent circuit shown in FIG. 16. In the equivalent circuit shown in FIG. 16, the resistance Rs corresponds to the impedance between the leading edge of the measuring electrode and the periodontal membrane and the capacitance Cs corresponds to the impedance between the periodontal membrane and the oral mucosa. In this embodiment, the capacitive component of the main conductive path and the impedance of the bypass path are approximated to the capacitance Cs as a unit.

Arithmetic operation to obtain elements of the equivalent circuit in this embodiment can be performed sufficiently provided using only two kinds of the measurement signals of the frequency f and the frequency 5f, because the elements of the equivalent circuit in FIG. 16 are two, i.e., one resistance and one capacitance. That is, the measurement signal of the frequency 25f for use in the second embodiment is not necessary in this embodiment. Thus, the dental diagnostic device according to this embodiment can not only simplify the measuring circuit but also facilitate calculation of the elements. The dental diagnostic device according to this embodiment has the same configuration as in the block diagram shown in FIG. 13 except that the oscillator 22 for the frequency 25f is not provided.

### <Detailed Operation of the Arithmetic Circuit>

The operation of the arithmetic circuit 28 according to this embodiment is basically the same as in the second embodiment, and impedance values between the measuring electrode and the oral mucosa corresponding to measurement signals having the frequency f and the frequency 5f are measured. The magnitudes of the elements (resistance Rs, capacitance Cs) of the equivalent circuit at respective measurement positions are obtained by establishing simultaneous equations based on the equivalent circuit of FIG. 16 and solving these simultaneous equations using the measured impedance values. Rs and Cs are obtained as equations 4 and 5. In this embodiment, the value of the capacitance Cs is used to detect the presence or absence of leakage current and that value is obtained according to an equation 5. In this embodiment also, the capacitance value of the capacitance Cs need not necessarily be obtained but a value corresponding to the capacitance value or a result of arithmetic operation by combining the resistance Rs with the capacitance Cs may be obtained.

$$\begin{matrix}Rs = \frac{5 {Z}_{5 f} - {Z}_{f}}{4} & [ Equation 4 ] \\ Cs = \frac{2}{5 π f ( {Z}_{f} - {Z}_{5 f} )} & [ Equation 5 ]\end{matrix}$$

As a simpler method, it is permissible to obtain and memorize in a table within the arithmetic circuit 28 the elements Rs, Cs through calculation in advance by combination of impedance values between the measuring electrode and the oral mucosa measured at the frequencies f and 5f, and introduce a value of an element (for example, capacitance Cs) from each impedance value obtained from the tooth 1 as a measurement object from that table. The table may be provided within the arithmetic circuit 28 or in an external memory section. Further, to suppress the quantity of data to be memorized in the table, data may be memorized discretely and interpolation processing may be used. Further, as data to be stored in the table, a value indicated on the display section or presence/absence of warning indication may be stored instead of the values of the elements Rs, Cs.

### SPECIFIC EXAMPLE

FIG. 17 shows a diagram in which the capacitance values of the element Cs in an extracted tooth having no fracture are plotted using the dental diagnostic device according to this embodiment. The abscissa axis of FIG. 17 indicates a distance (unit: mm) from the apex at the measuring electrode and the ordinate axis of FIG. 17 indicates the capacitance value of the element Cs in the unit of nano Farad. However, because the requirement here is that a relative magnitude can be specified, internal comparison in an actual apparatus configuration can be carried out in any other unit.

Graphs E, F, G shown in FIG. 17 indicate a case where leakage of strong electrolytic solution from the root canal orifice is present and the other graphs indicate a case where no leakage of strong electrolytic solution is present. As evident from the graphs in FIG. 17, values corresponding to the capacitance value of the element Cs differ between a case where leakage of strong electrolytic solution is present and leakage current from the root canal orifice is found and a case where no leakage current is present. Thus, the dental diagnostic device according to this embodiment can detect the existence of an electric leakage path (presence/absence of leakage current) by applying a predetermined determination standard to a value corresponding to the capacitance value of the element Cs. In the meantime, as the predetermined determination standard for detecting the existence of an electric leakage path (presence/absence of leakage current), a case where a value corresponding to the capacitance value of the element Cs is compared directly with a reference value which is a threshold, a case of obtaining a ratio between a value corresponding to the capacitance value and the reference value, a case of obtaining a difference between a value corresponding to the capacitance value and the reference value, a case of carrying out substantially the same arithmetic operation as for obtaining the ratio or difference by logarithmic arithmetic operation can be considered.

In the graphs E, F, G shown in FIG. 17, values corresponding to the capacitance value of the element Cs indicates a predetermined threshold (for example, 300) or more from the moment when the measuring electrode is inserted into the root canal, thereby indicating that a leakage current is present. In this embodiment also, the degree of the leakage current may be indicated corresponding to the capacitance value of the element Cs.

More specifically, the degree of leakage current may be indicated on the level meter 15 in which four LEDs are arranged in line as shown in FIG. 10. For example, this level meter is designed so that a level 1 LED is lit when a value corresponding to the capacitance value of the element Cs is 200, a level 2 LED is lit when a value corresponding to the capacitance value is 400, a level 3 LED is lit when a value corresponding to the capacitance value is 600 and a level 4 LED is lit when a value corresponding to the capacitance value is 800. In this case, detection values obtained from the graphs E, F, G in FIG. 17 are indicated as level 3 or level 4 and detection values obtained from the other graphs are indicated without lighting or as level 1 on the level meter. In the meantime, in this embodiment also, the indications shown in FIG. 5 or FIGS. 6 to 9 are permissible to suggest whether or not such a leakage current as to cause a problem clinically is present. Of course, the indication is not limited to visual one but it is permissible to use acoustic warning indication using a buzzer or a speaker.

As evident from the above-described result, if an electric leakage path exists due to presence of an abnormality in the shape of a tooth such as a fracture or collateral, the dental diagnostic device according to this embodiment is capable of detecting that existence.

Although in the second embodiment and the third embodiment, the existence of an electric leakage path is detected with values corresponding to the capacitance values Cp, Cs of the elements in the equivalent circuit adopted as data, the present invention is not limited to this example, but a variety of data concerning the root canal of the tooth can be obtained by designer's selecting the content of data appropriately. For example, a dental diagnostic device for detecting an abnormality in the root canal can be constructed using a combination of the capacitance value and resistance value as that data.

### Fourth Embodiment

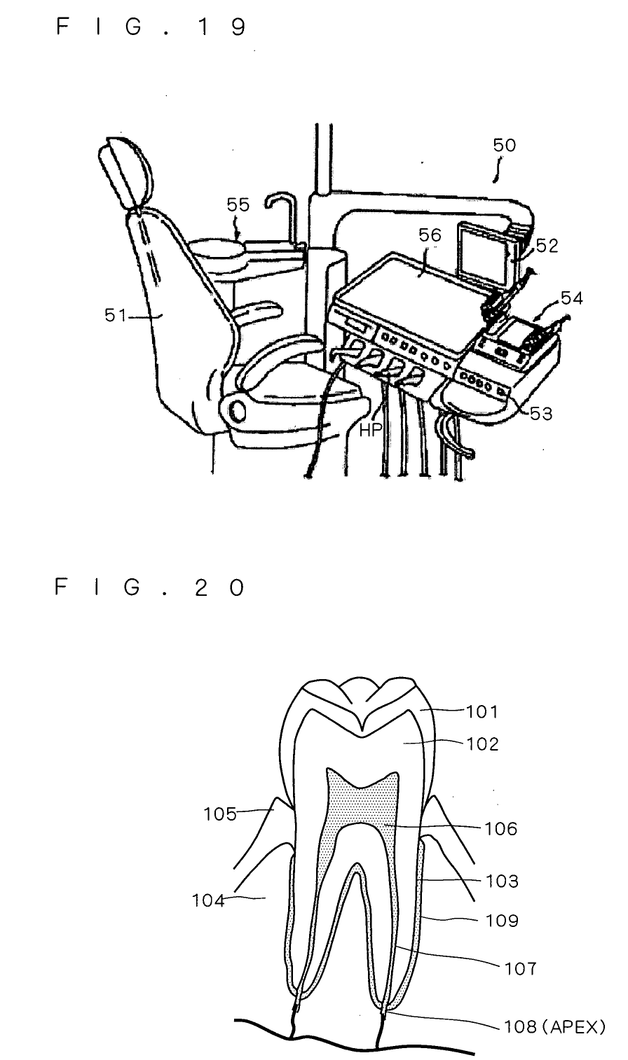

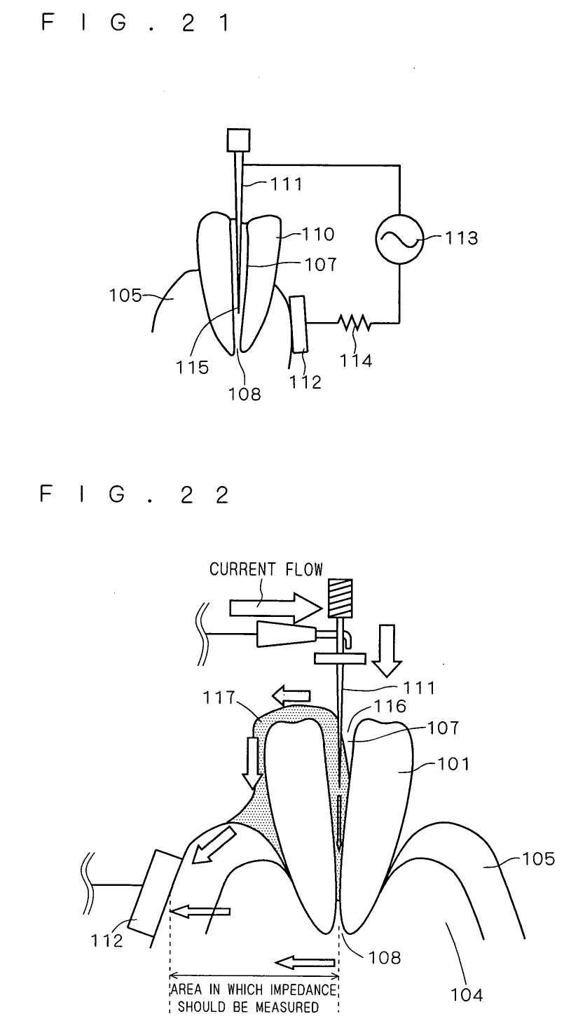

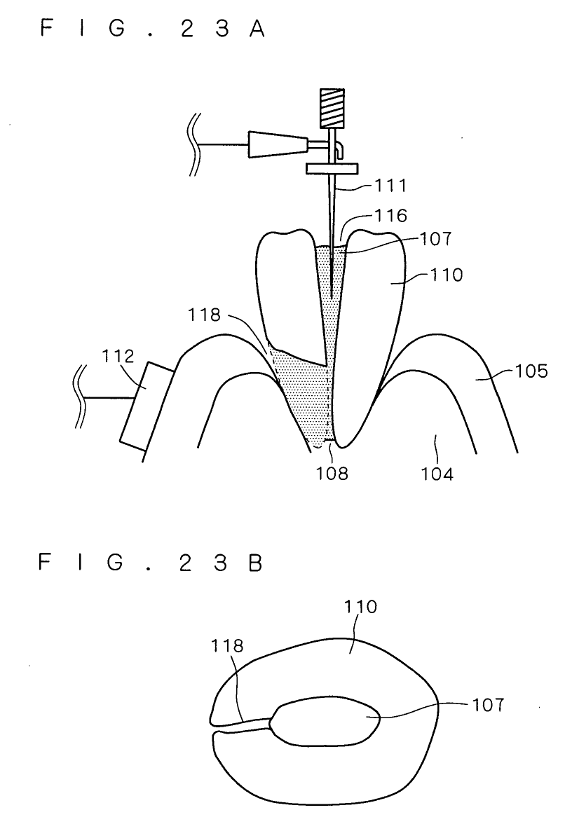

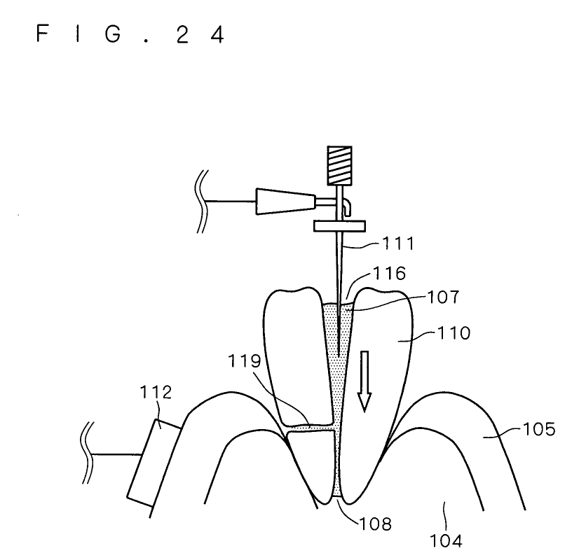

The dental diagnostic devices shown in the first to third embodiments can be incorporated in a root canal treating apparatus such as a root canal enlarging micro motor, a scaler and so on. A schematic diagram of the root canal treating apparatus is shown in FIG. 18. The root canal treating apparatus shown in FIG. 18 includes a hand piece H and a stand-alone control main unit C and the hand piece H is constituted by a head 41 provided with a cutting tool 40, a hand piece main body 42 and a shank 43 and connected to the control main unit C through a tube 44. The hand piece main body 42 incorporates a micro motor as a driving motor for the cutting tool 40.

The control main unit C includes a root canal length measuring circuit, the dental diagnostic device shown described in any of the first to third embodiments, an operating portions 45, and a display section 46. The measuring electrode 5 and the oral electrode 6 can be connected to the control main unit C. The root canal treating apparatus shown in FIG. 18 detects a root canal length and presence of an electric leakage path using the measuring electrode 5 and the oral electrode 6. In the meantime, although the measuring electrode 5 is provided independently of the hand piece H in the root canal treating apparatus shown in FIG. 18, the present invention is not limited to this example, but the measuring electrode 5 and the cutting tool 40 may be constructed together.

The dental diagnostic devices shown in the first to third embodiments or the root canal treating apparatus can be built into the dental diagnostic/treating table (dental diagnostic/treating unit). A dental diagnostic/treating table 50 shown in FIG. 19 includes a treatment table 51 which holds a patient in a seated position or in a face-up-lying position, a display section 52 which makes indications necessary for diagnosis and treatment, an operating portion 53 for receiving an operation input for diagnosis and treatment, a module portion 54 which incorporates the dental diagnostic device or the root canal treating apparatus, a spittoon portion 55 for allowing a patient to gargle and a moving table 56 on which devices necessary for diagnosis and treatment and the module portion 54 are mounted.

The dental diagnostic devices shown in the first to third embodiments and the root canal treating apparatus are built in the dental diagnostic/treating table (dental diagnostic/treating unit) 50 as the module portion 54 and information of the module portion 54 is displayed on the display section 52. In the meantime, the present invention is not limited to the dental diagnostic/treating table (dental diagnostic/treating unit) 50 shown in FIG. 19 but the dental diagnostic devices shown in the first to third embodiments or the root canal treating apparatus may be incorporated in the dental diagnostic/treating table in any formation.

Although the dental diagnostic devices shown in any of the first to third embodiments is equipped with the display section shown in FIGS. 5 to 10 integrally, the present invention is not limited to this example, but it is permissible to provide a display unit to which meter indication for the root canal length measurement indicating a root canal length measurement result and leakage indication indicating presence/absence of a leakage current are added, separately from the dental diagnostic device. Further, the display unit may be incorporated within the dental diagnostic/treating table (dental diagnostic/treating unit).

While the invention has been shown and described in detail, the foregoing description is in all aspects illustrative and not restrictive. It is therefore understood that numerous modifications and variations can be devised without departing from the scope of the invention.

What is claimed is:

1. A dental diagnostic device comprising:
a measuring electrode that is inserted into a root canal of a tooth as a measuring object;
an oral electrode that is brought into electric contact with oral mucosa;
a measurement signal applying means for applying a measurement signal in between said measuring electrode and said oral electrode;
a measuring means for obtaining data corresponding to the electric characteristic of at least part of a conductive path between said measuring electrode and said oral electrode based on measurement of an electric response to said measurement signal; and
a detecting means for detecting whether or not an electric leakage path bypassing an apex of said tooth is contained in said conductive path by applying a predetermined determination standard to said data.

2. The dental diagnostic device according to claim 1, wherein said electric leakage path is a path produced by leakage of a fluid in an area extending from a root canal orifice of said tooth to gingiva along the surface of said tooth.

3. The dental diagnostic device according to claim 1, wherein said electric leakage path is a path produced between the root canal of said tooth and gingiva originating from an abnormality in the shape of said tooth.

4. The dental diagnostic device according to claim 3, wherein at least one of fracture and collateral is contained as an abnormality in the shape of said tooth.

5. The dental diagnostic device according to claim 1, wherein said detecting means detects existence of said electric leakage path based on a result of comparing the value of said data with a predetermined threshold.

6. The dental diagnostic device according to claim 1, wherein the value of said data is an impedance value indicating said electric characteristic.

7. The dental diagnostic device according to claim 1, wherein said electric response is a response dependent upon the frequency of said measurement signal, and said measuring means measures an electric response between said measuring electrode and said oral electrode about each of the plurality of measurement signals each having a different frequency and adopts a result of arithmetic operation obtained from each of said electric responses as said data.

8. The dental diagnostic device according to claim 7, wherein the result of said arithmetic operation is a ratio of two impedance values obtained as said electric response about the plurality of measurement signals each having a different frequency.

9. The dental diagnostic device according to claim 1, wherein said electric response is a response dependent upon the frequency of said measurement signal, and said measuring means measures an electric response between said measuring electrode and said oral electrode about each of the plurality of measurement signals each having a different frequency and introduces said data by applying the result of measurement of the electric response to a predetermined table.

10. The dental diagnostic device according to claim 1, wherein said measuring means obtains an electric characteristic value of a predetermined portion of an equivalent circuit which is a modeling of said conductive path based on a result of measurement about the plurality of measurement signals each having a different frequency and adopts the electric characteristic value of said predetermined portion as said data.

11. The dental diagnostic device according to claim 10, wherein said equivalent circuit is so constructed that an equivalent circuit corresponding to the outside of the root canal is constituted of a resistance element and a capacitance element into a parallel circuit and a resistance element inside the root canal is connected to the parallel circuit in series.

12. The dental diagnostic device according to claim 10, wherein said equivalent circuit is so constructed that with the equivalent circuit corresponding to the outside of the root canal adopted as a capacitance element, a resistance element inside the root canal is connected to the capacitance element in series.

13. The dental diagnostic device according to claim 10, wherein said equivalent circuit is expressed as a parallel circuit configured by a main conductive path passing through an apical foramen of said tooth and a bypass path parallel to said main conductive path.

14. The dental diagnostic device according to claim 13, wherein said bypass path includes a portion corresponding to the parallel connection between a resistance component and a capacitance component.

15. The dental diagnostic device according to claim 1 further comprising a display section for displaying a result of determination by said detecting means.

16. The dental diagnostic device according to claim 15, wherein said display section visually displays the degree of a result obtained by said detecting means in a stepwise fashion.

17. The dental diagnostic device according to claim 15, wherein said display section visually displays the degree of a result obtained by said detecting means continuously.

18. The dental diagnostic device according to claim 15, wherein said display section executes acoustic indication corresponding to a result obtained by said detecting means.

19. A dental diagnostic device comprising:
a measuring electrode that is inserted into a root canal of a tooth as a measuring object;
an oral electrode brought into electric contact with oral mucosa;
a measurement signal applying means for applying a predetermined measurement signal in between said measuring electrode and said oral electrode;
a measuring means for measuring an electric response of a conductive path between said measuring electrode and said oral electrode corresponding to said measurement signal;
a detecting means for detecting that the value of data obtained from said electric response departs from a predetermined normal range or that it is departing therefrom; and
a display section for displaying information about said departure corresponding to a detection signal from said detecting means.

20. A root canal treating apparatus comprising:
a measuring electrode that is inserted into a root canal of a tooth as a measuring object;
an oral electrode brought into electric contact with oral mucosa;
a measurement signal applying means for applying a measurement signal in between said measuring electrode and said oral electrode;
a measuring means for obtaining data corresponding to the electric characteristic of at least part of a conductive path between said measuring electrode and said oral electrode based on measurement of an electric response to said measurement signal; and
a detecting means for detecting to see whether or not an electric leakage path bypassing an apex of said tooth is contained in said conductive path by applying a predetermined determination standard to said data.

21. A display unit for a root canal treating apparatus comprising:
a root canal length measuring means for obtaining information of a position of a leading edge of a measuring electrode inserted into a root canal of a tooth within the root canal;
a first display element for displaying in accordance with a result of the root canal measurement from said root canal length measuring means; and
a second display element for displaying in accordance with a detection signal indicating that an electric leakage path not passing through an apical foramen exists between said measuring electrode and an oral electrode brought into electric contact with oral mucosa.

22. A dental diagnostic/treating table comprising at least one of the dental diagnostic device according to claim 1, the root canal treating apparatus according to claim 20 and the display unit for a root canal treating apparatus according to claim 21.
